(19) United States
(12) Patent Application Publication
(10) Pub. No.: US 2022/0316135 A1
(43) Pub. Date: Oct. 6, 2022

(54) MOLDABLE CELLULOSE FIBER BASED MATERIAL

(71) Applicant: Stora Enso OYJ, Helsinki (FI)

(72) Inventors: Harri Setälä, Espoo (FI); Kari Kammiovirta, Tuusula (FI); Christiane Laine, Espoo (FI); Ali Harlin, Kerava (FI); Tuomo Hjelt, Helsinki (FI); Hanna Koskela, Espoo (FI); Jukka Ketoja, Kirkkonummi (FI)

(73) Assignee: Stora Enso OYJ, Helsinki (FI)

(21) Appl. No.: 17/597,272

(22) PCT Filed: Jul. 2, 2020
(86) PCT No.: PCT/IB2020/056250

§ 371 Date: Dec. 30, 2021

(30) Foreign Application Priority Data
Jul. 3, 2019 (SE) 1950835-7

(51) Int. Cl. D21C 9/00; D21H 11/20

(52) U.S. Cl. CPC D21C 9/004; D21C 9/005; D21H 11/20

(57) ABSTRACT

The present invention relates to a method for manufacturing modified cellulose fibers for a moldable cellulose fiber based material, said method comprising: a) providing a chemical or semi-chemical wood pulp comprising cellulose fibers, and optionally subjecting the pulp to alkaline extraction to obtain an alkaline extracted pulp; and b) subjecting the pulp or the alkaline extracted pulp of step a) to a chemical treatment with an alkaline solution and/or an organic solvent to obtain a treated pulp or treated alkaline extracted pulp comprising modified cellulose fibers for a moldable cellulose fiber based material. The invention further relates to a moldable cellulose fiber based material comprising at least 70% by dry weight of modified cellulose fibers obtainable by the method.

### TECHNICAL FIELD

The present disclosure relates to moldable cellulose fiber based materials and to methods for preparing such materials.

### BACKGROUND

Paper-based packaging materials, as renewable materials, have a growing market potential due to their sustainability. However, the development of new packaging concepts requires improvement in the mechanical properties of paper. High extensibility is one of these properties. Highly extensible papers would have the potential to replace certain kinds of plastics used in packaging.

Formability of a paper-based material can be defined as the ability of a material to deform without breaking. However, formability is not a specific mechanical property, but can be regarded as a generic term for explaining how well the paper deforms during a particular forming process. Formability can for example be estimated on the basis of a 2D experimental test method that simulates the process conditions in a fixed blank thermoforming process as described by Vishtal & Retulainen, 2014 (Improving the extensibility, wet web and dry strength of paper by addition of agar, Nord Pulp Pap Res J, 29:434-443). In the fixed blank process, the formability is determined by the extensibility and tensile strength of the paper. As yet, the fixed blank forming process has not been widely applied in industry for paperboard. Pulp fibers constitute the load-bearing components of paper. Kraft pulp fibers primarily consist of cellulose and hemicellulose. Cellulose is a crystalline, strong and stiff material with low extensibility making cellulosic fibers strong and stiff. However, mechanical treatment at high consistency possibly combined with a low consistency refining phase has been shown to improve the elongation potential of paper. Chemical treatment of pulp has been applied in order to modify the fiber material, especially the fiber surface, and its compatibility with polymer dispersions.

Elongation of some thermoplastic polymers can reach 400-800% and therefore, it is reasonable to expect that the addition of such polymers to the fiber network will improve the formability of the paper. Bio-based thermoplastic polymers are generally not hazardous to health and are also bio-degradable, which makes them suitable for use in food packages. Challenges of polymer applications to the pulp suspension are low retention in the fiber network and insufficient adhesion to the fibers. On the other hand, in cases where the polymer is applied on a formed fiber network, the retention is a less severe problem, but difficulties arise in the limited penetration of the polymer into the fiber network, and possibly in the limited adhesion.

In general, the forming processes for paper-based materials can be divided into two main categories: sliding and fixed blank processes. In the forming process with sliding blank (deep-drawing, stamping), forming proceeds due to the sliding of paper into the mold and lateral contraction of paper that causes microfolding of the paper. In the fixed blank process (hot pressing, hydroforming, air forming and vacuum forming) paper is formed via straining of the paper.

Usually, the sliding blank process produces shapes with a relatively high depth, while those produced in the fixed blank have significant limitations in depth. This is due to the fact that in the fixed blank process tensile deformation of paper prevails over compressive deformation. This means that only paper grades with high extensibility, high strength and post-forming stiffness are suitable for the fixed blank forming process. Moreover, fixed blank forming process yields shapes with smooth and even edges that enables the gas-tight sealing of formed shapes with barrier films. In contrast, the shapes produced in the sliding blank process have limitations in sealability due to microfolding/wrinkling, which also causes shape instability and impaired visual appearance.

Currently, there are two types of forming processes for paper substrate in commercial use: stamping for the production of trays and plates, and the Multivac® process (vacuum-assisted air forming) for the production of sealable trays for sliced cold cuts and cheeses. The emerging technologies in paper forming include deep-drawing, hydroforming and hot pressing (stamping with a fixed blank).

It can be concluded from the above discussion that paper substrates with improved extensibility and strength, or toughness, might open up new possibilities in the preparation of deep 3D shapes with smooth edges. Therefore, there remains a need for strategies for improving the paper toughness.

### SUMMARY OF THE INVENTION

It is an object of the present disclosure to alleviate at least some of the problems with the use of paper-based materials in preparation of deep 3D shapes with smooth edges.

It is a further object of the present disclosure to provide a cellulose fiber based material with improved formability, i.e. improved extensibility and strength, or toughness.

The above mentioned objects, as well as other objects as will be realized by the skilled person in the light of the present disclosure are achieved by the various aspects of the present disclosure.

The present inventors have surprisingly found that subjecting a chemical or semi-chemical wood pulp to chemical treatment with an alkaline solution and/or an organic solvent produces modified cellulose fibers providing significantly improved formability properties when used in a moldable cellulose fiber based material for forming deep 3D shapes with smooth edges.

According to a first aspect illustrated herein, there is provided a method for manufacturing modified cellulose fibers for a moldable cellulose fiber based material, said method comprising:
a) providing a chemical or semi-chemical wood pulp comprising cellulose fibers, and optionally subjecting the pulp to alkaline extraction to obtain an alkaline extracted pulp; and
b) subjecting the pulp or the alkaline extracted pulp of step a) to a chemical treatment with an alkaline solution and/or an organic solvent to obtain a treated pulp or treated alkaline extracted pulp comprising modified cellulose fibers for a moldable cellulose fiber based material.

The chemical treatment with an alkaline solution and/or an organic solvent of the optionally alkaline extracted pulp has been found to significantly improve the moldability of foam formed board containing the modified cellulose fibers compared to a corresponding foam formed board containing conventional untreated softwood pulp fibers. Thus, the modified cellulose fibers are preferably used for a deep drawable cellulose fiber based material for forming deep 3D shapes with smooth edges.

Without wishing to be bound to any particular scientific theory, it is noted that the treated pulp has more curly fibers than conventional pulp. This is shown in FIG. 1. These curly fibers create loops to the board structure. One hypothesis is that these loops will straighten out as the board is stretched during a molding process.

Also, the modified fibers of the treated pulp do not bond as strongly as in the case of normal softwood fibers, which together with the curliness of the fibers leads to a more horizontal stress-strain curve after the yield point as shown in FIG. 2. This stress-strain behaviour distributes the stresses in the fiber network evenly and increases the breaking strain.

It has further been found that the material obtained according to the inventive method tolerates elevated temperatures during subsequent molding steps, which provides the advantage that molding can be done in existing equipment available and today used for plastics.

The modified cellulose fibers are especially useful in moldable webs used as a precursor for preparation of deep 3D shaped articles. The term web as used herein refers generally to a continuous sheet of paper or paperboard manufactured or undergoing manufacture on a paper machine. The term web as used herein further refers to paper or paperboard substrate used for conversion into other physical forms, e.g. in the preparation of 3D shaped articles by deep drawing. In some embodiments, the moldable cellulose fiber based material is a moldable cellulose fiber based web material.

The web may for example be a water formed or foam formed web. In foam forming fibers and other furnish components are mixed with foam instead of water. The foam consists of water, foaming agent and air. Typical air content is in the range of 50-70%. The air bubbles prevent flocculation of fibers in the headbox.

The pulp used as the starting material for preparation of the modified pulp is a chemical or semi-chemical wood pulp. Chemical pulps are composed of cellulose, hemicelluloses and lignin, the latter of which is often present in very small quantities. However, unbleached and especially mechanical pulps have significantly higher lignin contents. Mechanical pulps are not preferred in the present invention, since the high lignin content may have a negative effect on paper extensibility. Webs prepared from mechanical pulps therefore typically have significantly lower elongation than webs prepared from chemical pulps. In some embodiments, the chemical or semi-chemical wood pulp is a softwood pulp.

The chemical or semi-chemical wood pulp comprising cellulose fibers can be used as is, or it can be subjected to alkaline extraction to obtain an alkaline extracted pulp. The alkaline extraction, whereby the pulp is subjected to extraction with an alkaline extraction solution, reduces the hemicellulose content of the pulp, which in some cases has been found to favorably influence the elongation of paper formed from the pulp. The alkaline extraction generally comprises contacting the pulp with an alkaline extraction solution, removing the alkaline extraction solution to obtain an alkaline extracted pulp, and optionally washing the alkaline extracted pulp. In some embodiments, the alkaline extraction comprises the steps:
a1) contacting the pulp with an alkaline extraction solution for 1-360 minutes,
a2) removing the alkaline extraction solution to obtain an alkaline extracted pulp, and
a3) optionally washing the alkaline extracted pulp.

As readily understood by the skilled person, various alkaline extraction solutions may be used for the optional alkaline extraction step. In some embodiments, the alkaline extraction solution is a NaOH, KOH or Mg(OH)₂ solution, preferably an aqueous solution. In some embodiments, the concentration of said alkaline extraction solution is in the range of 0.5-4 M, preferably in the range of 1-3 M.

The alkaline extraction may preferably be performed at room temperature, i.e. a temperature in the range of 20-25° C., but may also be performed at a temperature above or below room temperature.

The alkaline extraction may preferably be performed at atmospheric pressure, but may also be performed at a pressure above or below atmospheric pressure.

For practical reasons, the alkaline extraction contacting time is at least 1 minute. The contacting time may generally be in the range of 1-360 minutes. In some embodiments, the contacting time is in the range of 30-90 minutes.

The alkaline extracted pulp typically has a lower hemicellulose content as compared to the corresponding unextracted pulp. The alkaline extracted pulp may therefore also in some cases be referred to as hemipoor pulp.

The pulp or alkaline extracted pulp of step a) is then subjected to a chemical treatment in order to modify the cellulose fibers to make them more useful in a moldable cellulose fiber based material. The chemical treatment generally comprises contacting the pulp or alkaline extracted pulp of step a) with an alkaline solution and/or an organic solvent, completely or partially removing the alkaline solution and/or organic solvent to obtain a treated pulp or a treated alkaline extracted pulp comprising modified cellulose fibers for a moldable cellulose fiber based material, and optionally washing the treated pulp or treated alkaline extracted pulp.

In some embodiments, the chemical treatment comprises:
b1) contacting the pulp or alkaline extracted pulp of step a) with an alkaline solution and/or an organic solvent for at least 5 minutes,
b2) removing the alkaline solution and/or organic solvent to obtain a treated pulp or a treated alkaline extracted pulp comprising modified cellulose fibers for a moldable cellulose fiber based material, and
b3) optionally washing the treated pulp or treated alkaline extracted pulp.

In some embodiments, the chemical treatment comprises contacting the pulp or the alkaline extracted pulp of step a) with an alkaline solution.

In some embodiments, the chemical treatment comprises contacting the pulp or the alkaline extracted pulp of step a) with an organic solvent.

In some embodiments, the chemical treatment comprises contacting the pulp or the alkaline extracted pulp of step a) with a mixture of an alkaline solution and an organic solvent. A mixture of an alkaline solution and an organic solvent is also sometimes referred to herein as an alkaline solvent. The alkaline solvent may comprise 1-99% by weight of an alkaline solution and 1-99% by weight of an organic solvent, based on the total weight of the mixture.

In some embodiments, the alkaline solution is a NaOH, KOH or Mg(OH)₂ solution. In some embodiments, the concentration of said alkaline solution is in the range of 0.5-4 M, preferably in the range of 1-3 M.

In some embodiments, the solvent of the alkaline solution is water. In some embodiments, the solvent of the alkaline solution is a mixture of water and an organic solvent.

The organic solvent is preferably water miscible. In some embodiments, the organic solvent is a polar organic solvent, preferably a protic organic solvent, more preferably an alcohol, such as ethanol, isopropanol or tert-butanol.

In some embodiments the alkaline solution and/or an organic solvent comprises a mixture of an aqueous NaOH solution and tert-butanol. In some embodiments the concentration of NaOH in the mixture is in the range of 0.5-4 M in respect of total amount of water in the mixture.

The chemical treatment may preferably be performed at a temperature in the range of 20-60° C. In some embodiments, the chemical treatment is performed at a temperature in the range of 40-50° C. The chemical treatment may also be performed at room temperature, i.e. at a temperature in the range of 20-25° C.

The chemical treatment may preferably be performed at atmospheric pressure, but may also be performed at a pressure above or below atmospheric pressure.

For practical reasons, the chemical treatment contacting time is at least 5 minutes. The contacting time may generally be in the range of 5 minutes to 96 hours. In some embodiments, the contacting time is in the range of 24-60 hours.

Following chemical treatment with an alkaline solution, the treated pulp is preferably neutralized by an acid, preferably mineral acid, for example sulfuric acid.

The treated pulp or treated alkaline extracted pulp obtained in accordance with the first aspect, comprising modified cellulose fibers for a moldable cellulose fiber based material, are advantageously used in a moldable cellulose fiber based material. The chemical treatment with an alkaline solution and/or an organic solvent of the optionally alkaline extracted pulp has been found to significantly improve the moldability of foam formed board containing the modified cellulose fibers compared to a corresponding foam formed board containing conventional untreated softwood pulp fibers.

The modified cellulose fibers are especially useful in moldable webs used as a precursor for preparation of deep 3D shaped articles. In some embodiments, the moldable cellulose fiber based material is a moldable cellulose fiber based web material. The web may for example be a water formed or foam formed web.

It has been found that it is possible to mold board made of the inventive material without heat treatment, i.e. increased temperature during molding is not needed.

However, the material obtained according to the inventive method also tolerates elevated temperatures and thus current machinery (typically used for plastics) can be utilized.

According to a second aspect illustrated herein, there is provided a method for manufacturing a moldable cellulose fiber based material, said method comprising:
a) providing a treated pulp or treated alkaline extracted pulp comprising modified cellulose fibers for a moldable cellulose fiber based material according the first aspect; and
b) forming the treated pulp or treated alkaline extracted pulp, optionally together with additional components, into a dry moldable material.

The dry moldable material may for example be a cellulose fiber based web material or a premoulded structure.

In some embodiments, the moldable cellulose fiber based material formed is a moldable cellulose fiber based web material. The web material may for example be formed by water forming or by foam forming. The web material can then be used as a blank for preparation of deep 3D shaped articles by deep drawing techniques.

In order to optimally retain the improved moldability obtained by the chemical treatment, the treated pulp should not be dried until the moldable material, e.g. the web or premoulded structure, has been formed. It is believed that the chemical treatment changes the fiber walls of the cellulose, and this leads to increased stretchability of the fibers. Therefore, in some embodiments, the treated pulp or treated alkaline extracted pulp has not been dried before the moldable material has been formed.

According to a third aspect illustrated herein, there is provided a moldable cellulose fiber based material comprising at least 50%, and preferably at least 70%, by dry weight of modified cellulose fibers obtainable by, or obtained by, the method according to the first aspect.

In some embodiments, the moldable cellulose fiber based material comprises at least 80% by dry weight, preferably at least 90% by dry weight, more preferably at least 95% by dry weight, of the modified cellulose fibers.

In some embodiments, 100% of the cellulose fibers in the moldable cellulose fiber based web material are modified cellulose fibers obtainable by the method according to the first aspect.

In some embodiments, the moldable cellulose fiber based material comprises less than 30% by dry weight, preferably less than 20% by dry weight, more preferably less than 10% by dry weight, of added polymer.

In some embodiments, the moldable cellulose fiber based material comprises up to 30% by dry weight of an added polymer selected from the group consisting of starch, cellulose or other polysaccharides including their derivatives, polylactic acid, polyurethane, polyolefins, dispersions of acrylates, styrene/butadiene or vinyl acetate, and mixtures thereof.

In some embodiments, the moldable cellulose fiber based material comprises up to 25%, or even up to 50%, by dry weight of inorganic or organic fillers for example particles selected from the group consisting of gypsum, silicate, talc, plastic pigment particles, kaolin, mica, calcium carbonate, including ground and precipitated calcium carbonate, bentonite, alumina trihydrate, titanium dioxide, phyllosilicate, synthetic silica particles, organic pigment particles and mixtures thereof.

In some embodiments, the moldable cellulose fiber based material is a moldable cellulose fiber based web material. The web may for example be a water formed or foam formed web.

In some embodiments, the modified cellulose fibers of the moldable cellulose fiber based web material have not been dried subsequent to the chemical treatment.

In some embodiments, the moldable cellulose fiber based web material has a 2D elongation at least 10% higher, preferably at least 20% higher, preferably at least 30% higher, preferably at least 40% higher, preferably at least 50% higher, preferably at least 60% higher, preferably at least 70% higher, preferably at least 80% higher, preferably at least 90% higher, preferably at least 100% higher, than the 2D elongation of a corresponding cellulose fiber based web material wherein the cellulose fibers are unmodified. In some embodiments, the moldable cellulose fiber based web material has a 2D elongation of at least 10%, preferably at least 20%. The 2D elongation of a corresponding cellulose fiber based web material wherein the cellulose fibers are unmodified is typically around 5%.

The moldable cellulose fiber based web material preferably has a basis weight and thickness suitable for conversion into deep 3D shaped articles by deep drawing techniques.

In some embodiments, the moldable cellulose fiber based web material has a basis weight in the range of 50-500 g/m².

In some embodiments, the moldable cellulose fiber based web material is polymer coated. The polymer coating of the polymer coated web material may comprise any of the polymers commonly used in paper or paperboard based packaging materials in general or polymers used in liquid packaging board in particular. Examples include polyethylene (PE), polyethylene terephthalate (PET), polypropylene (PP) and polylactic acid (PLA). Polyethylenes, especially low density polyethylene (LOPE) and high density polyethylene (HDPE), are the most common and versatile polymers used in packaging board for liquid containing food products.

The polymer coating preferably comprises a heat sealable polymer. Using a heat sealable polymer allows for efficient sealing of the container by heat sealing of a lid or sealing film to the container.

The polymer coating preferably comprises a thermoplastic polymer. In some embodiments, the polymer coating comprises a polyolefin. Thermoplastic polymers, and particularly polyolefins are useful since they provide good heat sealing properties and can be conveniently processed by extrusion coating techniques to form very thin and homogenous films with good liquid barrier properties. In some embodiments, the polymer layer comprises a polypropylene or a polyethylene. In preferred embodiments, the polymer layer comprises a polyethylene, more preferably LDPE or HDPE.

The basis weight of the polymer layer of the inventive gas barrier film is preferably less than 50 g/m². In order to achieve a continuous and substantially defect free film, a basis weight of the polymer layer of at least 8 g/m², preferably at least 12 g/m² is typically required. In some embodiments, the basis weight of the polymer layer is in the range of 8-50 g/m², preferably in the range of 12-50 g/m².

According to a fourth aspect illustrated herein, there is provided a molded product comprising modified cellulose fibers obtainable by the method according to the first aspect.

The molded product may for example be a 3D shaped receptacle. Non-limiting examples of such receptacles include trays, plates, bowls and cups. The receptacles may for example have a substantially square (e.g. quadratic or rectangular), substantially polygonal (e.g. hexagonal) or substantially round (e.g. circular or elliptic) geometry. The receptacle may be used, among other purposes, for storage and transport of fresh or frozen food. In some embodiments, the containers may also be used for conventional or microwave preparation of food. The receptacle is preferably formed from a single piece of substrate material. Within the context of this document, the phrase a “single piece of material” includes a single piece of material that comprises a single layer or multiple layers of the same material or multiple layers of different materials. These multi-layered materials could include, for example, layers of two or more paper and/or paperboard substrates completely bonded together and/or partially bonded together, such as a corrugated board material, with or without any other layer or layers of any other materials such as metal, foil, plastic, and so forth. Thus, laminates formed from two or more differing types of material are nonetheless encompassed by the phrase a “single piece of material”.

The molded product is preferably prepared by deep drawing techniques using a moldable cellulose fiber based web material. In some embodiments, the molded product is made of a moldable cellulose fiber based web material according to the third aspect. In a preferred embodiment, the molded product is made of a single piece of a moldable cellulose fiber based web material according to the third aspect.

The invention will now be described more in detail with reference to specific examples.

While the invention is described herein with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

### BRIEF DESCRIPTION OF THE DRAWINGS

FIG. 1 shows CCD camera images of (a) a conventional, untreated softwood pulp, and (b) the inventive moldable pulp.

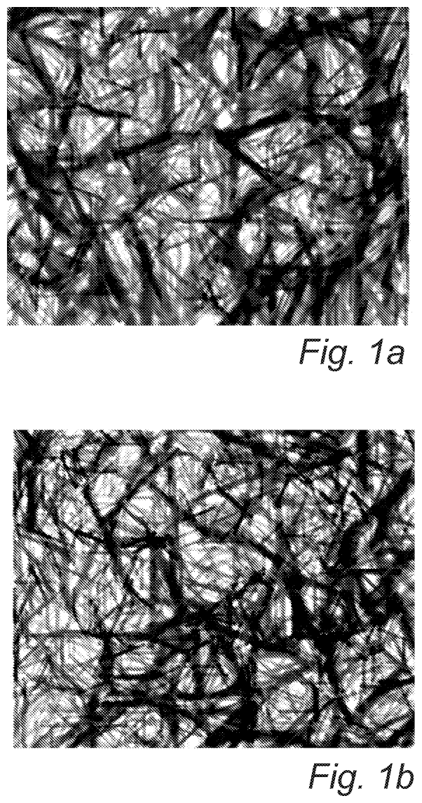

FIG. 2 is a diagram showing stress-strain curves of conventional, untreated softwood pulp, mechanically treated pulp, and the inventive moldable pulp.

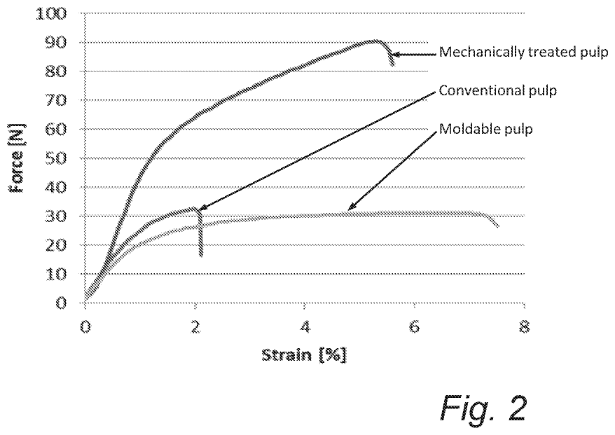

FIG. 3 is a schematic representation showing the 2D formability tester used for measuring the formability strain and strength of the modified sheets.

FIG. 4 shows the 2D tension vs. strain curves to different pulps.

### EXAMPLES

### Example 1—Alkaline Extraction of Cellulose Pulp

Softwood kraft cellulose pulp (SE SW) was first extracted with 2.5 M NaOH (100 g NaOH/L) at 20-25° C. for 1 h in pulp consistency 10 wt %. The extracted pulp was washed by filtering and pH was adjusted to pH 8-9. The dry matter content of extracted pulp was approximately 35 wt %. The yield of extracted pulp was 86.5% (average of four extraction batches, +1-1.3%). This cellulose pulp, referred to herein as Reference 1, was then used as a starting material for the chemical treatment.

### Example 2—Chemical Treatment of Alkaline Extracted Cellulose Pulp

1500 g of Reference 1 pulp was weighed and added into a 60 L reaction flask with 14000 ml of water and with 13000 ml of 90% aqueous tert-butanol. Then 1220 g of 50% NaOH solution was added to adjust the molarity of NaOH to 1.1-1.5 M in respect of the total amount of water in the reaction mixture. The reaction mixture was stirred for 48 h at 45° C. The reaction mixture was then neutralized with 400 ml of concentrated sulfuric acid diluted with water to 1/10 before addition into the reactor. The samples were filtrated and washed carefully with 10 L of 100% ethanol, and finally 3×20 L of water to remove organic solvents and salts. The obtained chemically treated kraft cellulose pulp is referred to herein as Reference 2.

### Example 3—Chemical Treatment of Non-Extracted Cellulose Pulp

Softwood kraft cellulose pulp as used in Example 1, was used as the starting material. 500 g of the starting material was weighed and added into a 60 L reaction flask with 4000 ml of water and with 3000 ml of 90% aqueous tert-butanol. Then 400 g of 50% NaOH solution was added to adjust the molarity of NaOH to 1.1-1.5 M in respect of the total amount of water in the reaction mixture. The reaction mixture was stirred for 48 h at +45° C. The reaction mixture was then neutralized with 130 ml of concentrated sulfuric acid diluted with water to 1/10 before addition into the reactor. The samples were filtrated and washed carefully with 3 L of 100% ethanol, and finally 3×10 L of water to remove organic solvents and salts. The obtained chemically treated non-extracted pulp is referred to herein as Reference 3.

### Example 4—Preparation of Laboratory Sheets by Foam Forming

The foam formed laboratory sheets were prepared as follows:

1. Foam was produced by mixing the cellulose pulp, with water, surface active agent (SDS), and optional additives, until the air content of foam was ˜60-70%. Also retention aids or fixative were used in some trial points. The basis weight was 200 g/m².
2. Foam was poured into a hand sheet mold.
3. Sheet was formed to the screen by removing the foam with a vacuum.
4. Sheet was removed with the wire from the mold and pre-dried by transferring wire on a special suction table by using an exhauster. The suction table has a suction slit, width 5 mm, and it sucks air through the sheet with 0.2 bar vacuum.
5. No wet pressing was done.
6. The pre-dried sheets were dried overnight. The drying shrinkage was restrained.

### Example 5—Analysis of Hand Sheets

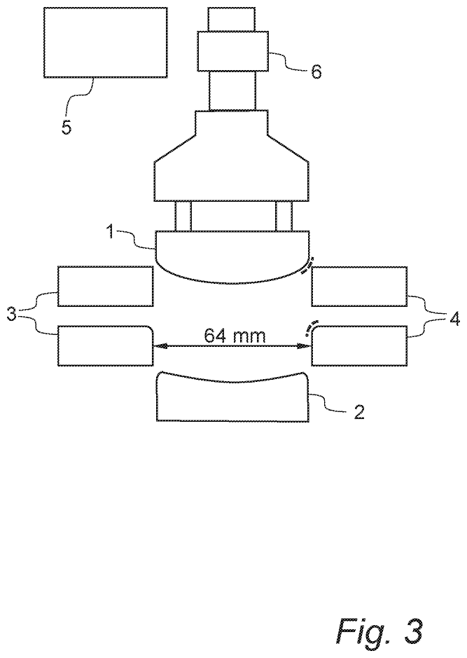

Formability strain and strength of modified sheets were measured using a 2D formability tester developed by VTT in Jyväskylä, Finland. The 2D formability tester is shown in FIG. 3. The objective of the 2D formability tester is to simulate the thermoforming process in 2D-scale. The unit is equipped with a double-curved heated press (1) and bottom support (2) (allowing for temperatures up to 250° C.) and blank holders (3,4). Typically, a paper with a grammage range from 80 to 250 g/m² can be preheated to the die temperature within 0.5-0.7 s. In practice, this means that the temperature of the paper at the moment of forming is close to that of the die.

The testing proceeds as follows: the two blank holders (3,4) fix a paper sample (20-30 mm wide and more than 100 mm long). The press (1) is then moved into contact with the sample and retained still for 0.5 s in order to preheat the sample. Then, the press continues a downward movement until breakage of the sample. Displacement and load of the press is measured by a displacement sensor (5) and load sensor (6) respectively. The velocity of the forming press was 1 mm/s. The formability strain and strength of the samples was measured as an average value collected from 7 samples at die temperature of 90-140° C.

The geometry of the press surface, as well as the geometry of the sample holder was taken into account when calculating the 2D formability strain value. The sample holders have an absolute blank holding, so no slipping of the sample took place during the test.

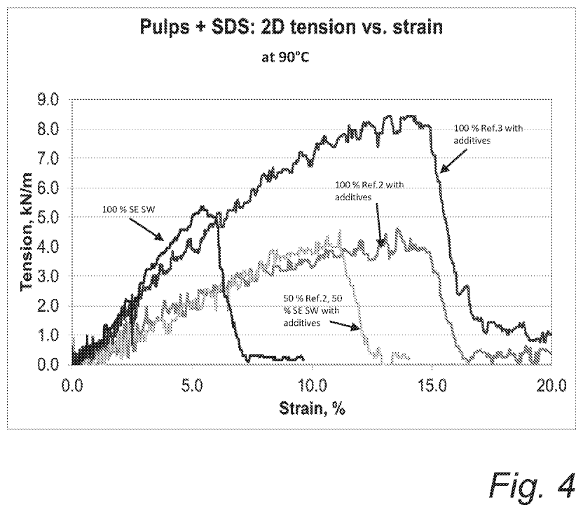

The results of the measurements are presented in FIG. 4 and in Table 1.

TABLE 1

| Formulation | 2D strain, % |
|---|---|
| 100% Ref. 2 + SDS without additives | 10.5 |
| 100% Ref. 2 + SDS with additives | 14.3 |
| 50% Ref. 2 + 50% SE SW pulp + SDS | 10.7 |
| with additives | |
| 100% Ref. 3 + SDS with additives | 14.5 |
| 100% SE SW + SDS without additives | 5.4 |

Additives = 30% polyurethane (Impranil DL 519, Covestro) and 600 g/tn CPAM (Perform PC 435, Solenis) and microparticles (Perform 7200, Solenis)

1. A method for manufacturing modified cellulose fibers for a moldable cellulose fiber based material, said method comprising:
a) providing a chemical or semi-chemical wood pulp comprising cellulose fibers; and
b) subjecting the pulp of step a) to a chemical treatment with an alkaline solution, an organic solvent, or both to obtain a treated pulp comprising modified cellulose fibers for a moldable cellulose fiber based material.

2. The method according to claim 1, wherein the moldable cellulose fiber based material is a moldable cellulose fiber based web material.

3. The method according to claim 1, wherein said chemical or semi-chemical wood pulp is a softwood pulp.

4. The method according to claim 1, wherein the pulp is subjected to an alkaline extraction before step b), wherein said alkaline extraction comprises:
a1) contacting the pulp with an alkaline extraction solution for 1-360 minutes, and,
a2) removing the alkaline extraction solution to obtain an alkaline extracted pulp.

5. The method according to claim 4, wherein said alkaline extraction solution comprises a NaOH, KOH or Mg(OH)₂ solution.

6. The method according to claim 5, wherein the concentration of said alkaline extraction solution is in the range of 0.5-4 M.

7. The method according to claim 1, wherein said chemical treatment comprises:
b1) contacting the pulp of step a) with an alkaline solution, an organic solvent, or both for at least 5 minutes, and,
b2) removing the alkaline solution and the organic solvent to obtain the treated pulp.

8. The method according to claim 1, wherein said chemical treatment comprises contacting the pulp of step a) with a mixture of an alkaline solution and an organic solvent.

9. The method according to claim 8, wherein said alkaline solution is a NaOH, KOH or Mg(OH)₂ solution.

10. The method according to claim 9, wherein the concentration of said alkaline solution is in the range of 0.5-4 M.

11. The method according to claim 8, wherein said organic solvent is a polar organic solvent.

12. A method for manufacturing a moldable cellulose fiber based material, said method comprising:
a) providing the treated pulp according to claim 1; and
b) forming the treated pulp into a moldable cellulose fiber based material.

13. The method according to claim 12, wherein the moldable cellulose fiber based material is a moldable cellulose fiber based web material.

14. The method according to claim 12, wherein the treated pulp has not been dried before the moldable material has been formed.

15. A moldable cellulose fiber based material comprising:
at least 70% by dry weight of modified cellulose fibers obtained by the method according to claim 1.

16. The moldable cellulose fiber based material according to claim 15, comprising:
at least 80% by dry weight of modified cellulose fibers obtained by the method according to claim 1.

17. The moldable cellulose fiber based material according to claim 16, wherein 100% of the cellulose fibers in the moldable cellulose fiber based web material are modified cellulose fibers obtained by the method according to claim 1.

18. The moldable cellulose fiber based material according to claim 15, comprising less than 30% by dry weight of added polymer.

19. The moldable cellulose fiber based material according to claim 15, wherein the moldable cellulose fiber based material is a moldable cellulose fiber based web material.

20. The moldable cellulose fiber based web material according to claim 19, wherein said moldable cellulose fiber based web material has a 2D elongation at least 10% higher than the 2D elongation of a corresponding cellulose fiber based web material wherein the cellulose fibers are unmodified.

21. The moldable cellulose fiber based web material according to claim 15, wherein the moldable cellulose fiber based web material a basis weight in the range of 50-500 g/m².

22. (canceled)
